(19) United States
(12) Patent Application Publication
(10) Pub. No.: US 2008/0183948 A1
(43) Pub. Date: Jul. 31, 2008

(54) Flash memory system with higher data transmission rate and method thereof

(76) Inventors: Satoshi Sugawa, Hsinchu (TW); Ching-Hu Chen, Hsinchu (TW); Wen-Lin Cheng, Hsinchu (TW); Kai-Hsun Lin, Hsinchu (TW); Fuja Shone, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 11/669,171

(22) Filed: Jan. 31, 2007

(51) Int. Cl. G06F 1/10; G06F 12/02

(52) U.S. Cl. 711/103; 713/600; 711/E12.008

(57) ABSTRACT

A flash memory system is disclosed. The flash memory system includes a host and a flash memory card. The data transmission between the host and the flash memory card can be achieved with a clock signal for synchronization. The data is transmitted between the host and the flash memory card both at the falling edges and the rising edges of the clock signal.

### BACKGROUND OF THE INVENTION

1. Field of the Invention

The present invention provides a flash memory system, and more particularly, a flash memory system with a higher data transmission rate.

2. Description of the Prior Art

Please refer to FIG. 1. FIG. 1 is a diagram illustrating a conventional flash memory system 100. The flash memory system 100 comprises a host 110 and a flash memory card 120. The flash memory card 120 is coupled to the host 110. The host 110 has a clock port for transmitting a clock signal CLK, and a data port for exchanging data DAT. The flash memory card 120 is coupled to the host 110 through the clock port for receiving the clock signal CLK, and through the data port for exchanging the data DAT. When the flash memory card 120 is coupled to the host 110, the host 110 is able to store data in the flash memory card 120 or retrieve data from the flash memory card 120. When the host 110 transmits data DAT to the flash memory card 120, the host 110 transmits a command through the data port to the flash memory card 120 to enable the flash memory card 120 to be ready to receive the data DAT, and provides a clock signal CLK for synchronization. It is also similar when the host receives data from the flash memory card 120.

Please refer to FIG. 2. FIG. 2 is a diagram illustrating the data DAT transmission between the host 110 and the flash memory card 120. As shown in FIG. 2, the data DAT has n bits D0, D1, D2 . . . , and Dn. At the first rising edge of the clock signal CLK, the first bit D0 is transmitted. As the next rising edge of the clock signal CLK, the second bit D1 is transmitted. Thus, the bit Dn is transmitted at the n+1th rising edge of the clock signal CLK. It is assumed that the period of the clock signal CLK is T. Therefore, the total transmission time of the n-bit data DAT is nT.

The conventional method to increase the data transmission rate is to increase the frequency of the clock signal CLK, meaning the period T is decreased. But the frequency of the clock signal CLK has a ceiling which is about 50 MHz. If the frequency of the clock signal CLK is higher than 50 MHz, the transmission quality becomes deteriorated because more and more noises cannot be ignored. Thus, the data transmission rate of the conventional flash memory system is limited by the frequency of the clock signal CLK.

### SUMMARY OF THE INVENTION

The present invention provides a method for data transmission with higher transmission rate. The method comprises transmitting a first set of data at a rising edge of a clock signal; and transmitting a second set of data at a falling edge immediately after the rising edge of the clock signal.

The present invention further provides a method for data transmission with higher transmission rate. The method comprises transmitting a first set of data at a falling edge of a clock signal; and transmitting a second set of data at a rising edge immediately after the falling edge of the clock signal.

The present invention provides a host with higher transmission rate. The host comprises a clock port; a data port; a processor comprising a data bus port for transmitting a command; a buffer controller comprising a data bus port coupled to the data bus port of the processor for receiving the command; a first input port for receiving odd sets of data; a second input port for receiving even sets of data; a first output port for transmitting odd sets of data; and a second output port for transmitting even set of data; an oscillator for outputting a clock signal; a transmission module coupled between the buffer controller, the oscillator, and the data port for transmitting data from the buffer to the data port according to the clock signal; and a receiving module coupled between the buffer controller, the oscillator, and the data port for receiving data from the data port and transmitting the received data to the buffer controller according to the clock signal.

The present invention further provides a flash memory card with higher transmission rate. The flash memory card comprises a data port; a clock port for receiving a clock signal; a clock tree coupled to the clock port for buffering the clock signal and accordingly generating a buffered clock signal; a buffer controller comprising a first input port for receiving odd sets of data; a second input port for receiving even sets of data; a first output port for transmitting odd sets of data; and a second output port for transmitting even set of data; a transmission module coupled to the buffer controller, the clock tree, and the data port for transmitting data according to rising edges and falling edges of the buffered clock signal; a receiving module coupled to the buffer controller, the clock tree, and the data for receiving data according to rising edges and falling edges of the buffered clock signal; and a flash memory storage device coupled to the buffer controller for storing data.

The present invention further provides a flash memory card with higher transmission rate. The flash memory card comprises a data port; a clock port for receiving a clock signal; a clock tree coupled to the clock port for buffering the clock signal and accordingly generating a buffered clock signal; a buffer controller comprising a first input port for receiving odd sets of data; a second input port for receiving even sets of data; a first output port for transmitting odd sets of data; and a second output port for transmitting even set of data; a transmission module coupled to the buffer controller, the clock port, the clock tree, and the data port for transmitting data according to rising edges and falling edges of the buffered clock signal; a receiving module coupled to the buffer controller, the clock tree, and the data port for receiving data according to rising edges and falling edges of the buffered clock signal; and a flash memory storage device coupled to the buffer controller for storing data.

The present invention further provides a flash memory system with higher transmission rate. The flash memory system comprises a clock port; a data port; a host comprising a processor comprising a data bus port for transmitting a command; a buffer controller comprising a data bus port coupled to the data bus port of the processor for receiving the command; a first input port for receiving odd sets of data; a second input port for receiving even sets of data; a first output port for transmitting odd sets of data; and a second output port for transmitting even set of data; an oscillator for outputting a clock signal; a transmission module coupled between the buffer controller, the oscillator, and the data port for transmitting data from the buffer to the data port according to the clock signal; and a receiving module coupled between the buffer controller, the oscillator, and the data port for receiving data from the data port and transmitting the received data to the buffer controller according to the clock signal; and a flash memory card coupled to the clock port and the data port for transmitting or receiving data through the data port according to the clock signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional flash memory system.

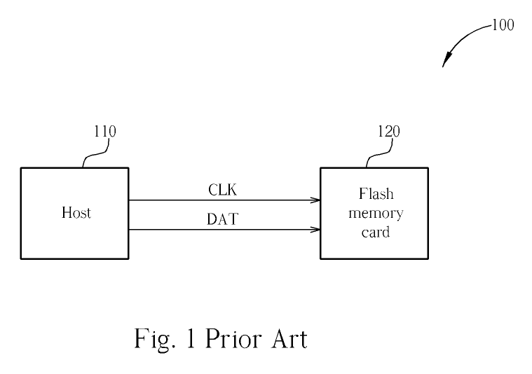

FIG. 2 is a diagram illustrating the data transmission between the conventional host and the conventional flash memory card.

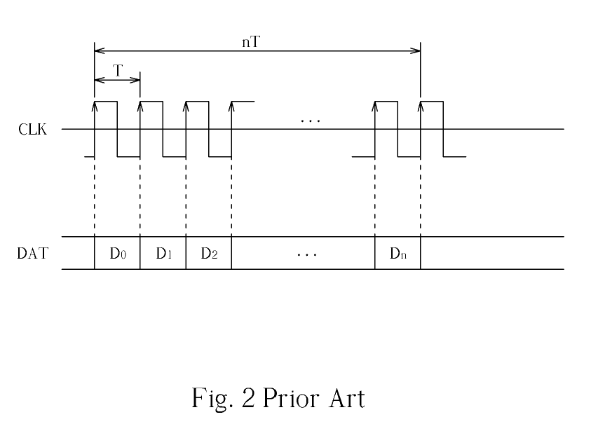

FIG. 3 is a diagram illustrating the data transmission of a first embodiment of the present invention.

FIG. 4 is a diagram illustrating the data transmission of a second embodiment of the present invention.

FIG. 5 is a diagram illustrating a host of a first embodiment of the present invention.

FIG. 6 is a memory card of a first embodiment of the present invention.

FIG. 7 is a circuit diagram illustrating a receiving module of a first embodiment of the memory card of the present invention.

FIG. 8 is a circuit diagram illustrating a transmission module of a first embodiment of the memory card of the present invention.

FIG. 9 is a timing diagram illustrating the timing relation of the transmission module in FIG. 8 when the memory card transmits data.

FIG. 10 is a circuit diagram illustrating a transmission module of a second embodiment of the memory card of the present invention.

FIG. 11 is a timing diagram illustrating the timing relation of the transmission module in FIG. 10 when the memory card transmits data.

FIG. 12 is a circuit diagram illustrating a transmission module of a third embodiment of the memory card of the present invention.

FIG. 13 is a timing diagram illustrating the timing relation of the transmission module in FIG. 12 when the memory card transmits data.

FIG. 14 is a circuit diagram illustrating a transmission module of a forth embodiment of the memory card of the present invention.

FIG. 15 is a timing diagram illustrating the timing relation of the transmission module in FIG. 14 when the memory card transmits data.

FIG. 16 is a diagram illustrating a memory card of a second embodiment of the present invention.

FIG. 17 is a circuit diagram illustrating a transmission module of a first embodiment of the flash memory card of the present invention.

FIG. 18 is a timing diagram illustrating the timing relation of the transmission module in FIG. 17 when the memory card transmits data.

FIG. 19 is a circuit diagram illustrating a transmission module of a second embodiment of the flash memory card of the present invention.

FIG. 20 is a timing diagram illustrating the timing relation of the transmission module in FIG. 19 when the memory card transmits data.

### DETAILED DESCRIPTION

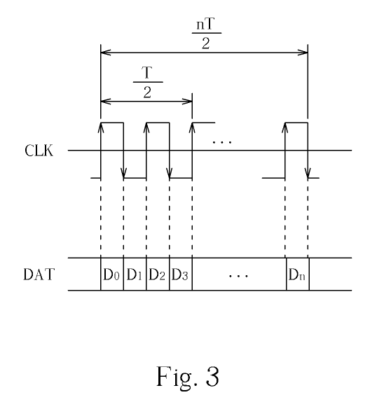

Please refer to FIG. 3. FIG. 3 is a diagram illustrating the data transmission of a first embodiment of the present invention between the host and the flash memory card of the present invention. In the flash memory system of the present invention, the data DAT is transmitted at both the rising edge and the falling edge of the clock signal CLK. Consequently during the period T, 2 bits of data are transmitted, meaning the data transmission rate is almost doubled. As shown in FIG. 3, the data DAT has n bits D0, D1, D2 . . . , and Dn. At the first rising edge of the clock signal CLK, the first bit D0 is transmitted. At the first falling edge of the clock signal CLK, the second bit D1 is transmitted. Therefore, the total transmission time of the n-bit data DAT is nT/2. It is also similar when the host receives data from the flash memory card.

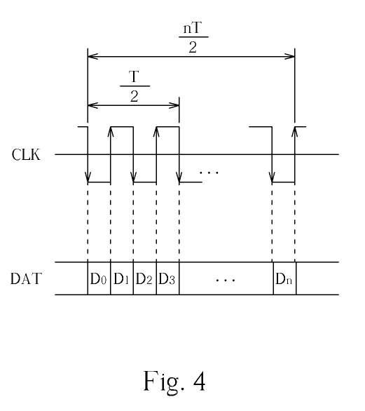

Please refer to FIG. 4. FIG. 4 is a diagram illustrating the data transmission of a second embodiment of the present invention between the host and the flash memory card of the present invention. The idea of the FIG. 4 is similar to FIG. 3 and the difference is that in FIG. 4, the first bit D0 is transmitted at the falling edge of the clock signal CLK. Thus, at the first rising edge of the clock signal CLK, the second bit D1 is transmitted. Therefore, the total transmission time of the n-bit data DAT is also reduced to nT/2.

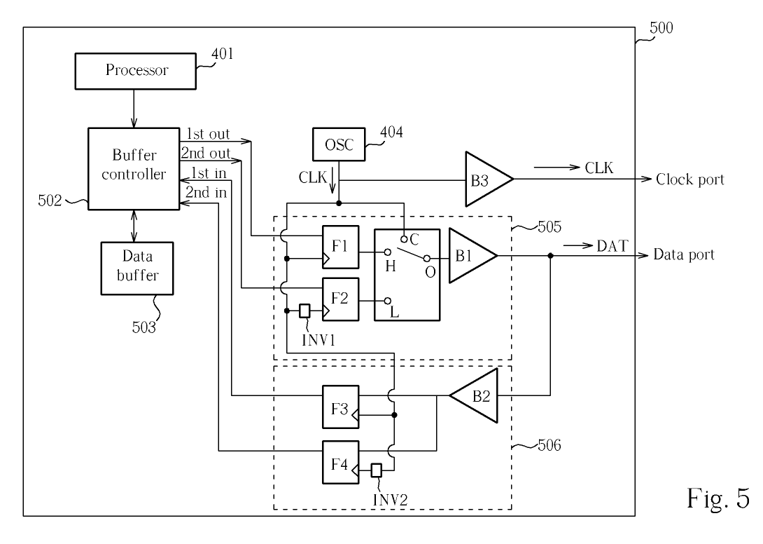

Please refer to FIG. 5. FIG. 5 is a diagram illustrating a host 500 of a first embodiment of the present invention. The host 500 comprises a processor 501, a buffer controller 502, a data buffer 503, an oscillator 504, a transmission module 505, a receiving module 506, and a buffer B3. Besides, the host 500 also comprises a clock port to transmit the clock signal CLK to external devices, and a data port to exchange the data DAT with the external devices.

The processor 501 has a data bus port coupled to buffer controller 502 for transmitting a buffer control command to the buffer controller 502. The buffer controller 502 has a first and a second output ports for transmitting data and a first and a second input ports for receiving data according to the buffer control command. The data buffer 503 is coupled to the buffer controller 502 for data buffering.

The oscillator 504 is coupled to the clock port through the buffer B3. Because the clock signal CLK is transmitted to the external devices, it has to be buffered with more current sizes or higher voltage levels so as to resist external noises and avoid errors when the external devices receive the clock signal CLK. Thus the clock signal CLK is buffered and transmitted to the clock port.

The transmission module 505 comprises two flip-flops F1 and F2, a selection device S1, an inverter INV5, and a buffer B1. The flip-flop F1 comprises an input port coupled to the first output port of the buffer controller 502 to receive the data output from the buffer controller 502, a control port coupled to the oscillator 504 to receive the clock signal CLK, and an output port coupled to the selection device S1. At the rising edges of the clock signal CLK, the flip-flop F1 transmits the data received at the input port to the output port. The flip-flop F2 comprises an input port coupled to the second output port of the buffer controller 502 to receive the data output from the buffer controller 502, a control port coupled to the inverter INV5 to receive the inverted clock signal ICLK, and an output port coupled to the selection device S1. At the rising edges of the inverted clock signal ICLK, meaning at the falling edge of the clock signal CLK, the flip-flop F2 transmits the data received at the input port to the output port. The selection device S1 comprises input ports H and L respectively coupled to the output port of the flip-flop F1 and the output port of the flip-flop F2, a control port C coupled to the oscillator 504, and an output port O coupled to the buffer B1. When the clock signal CLK is high, the selection device S1 couples the input port H to the output port O, and when the clock signal CLK is low, the selection device S1 couples the input port L to the output port O. The buffer B1 is designed for buffering the data ready to transmit. Because the data is transmitted to the external devices, it has to be buffered with more current sizes or higher voltage levels so as to resist external noises and avoid misreading when the external devices receive the data. Thus the data is buffered by the buffer B1 and transmitted to the data port. The buffer B1 comprises an input port coupled to the output port O of the selection device S1 and an output port coupled to the data port.

The receiving module 506 comprises a buffer B2, an inverter INV4, and two flip-flops F3 and F4. The flip-flop F3 comprises an input port coupled to the output port of the buffer B2 to receive data from the buffer B2, a control port coupled to the oscillator 504 to receive the clock signal CLK, and an output port coupled to the first input port of the buffer controller 502. At the rising edges of the clock signal CLK, the flip-flop F3 transmits the data received at the input port to the output port. The flip-flop F4 comprises an input port coupled to the output port of the buffer B2 to receive data from the buffer B2, a control port coupled to the inverter INV4 to receive the inverted clock signal ICLK, and an output port coupled to the second input port of the buffer controller 502. At the rising edges of the inverted clock signal CLK, meaning the falling edges of the clock signal CLK, the flip-flop F4 transmits the data received at the input port to the output port. The buffer B2 comprises an input port coupled to the data port and an output port coupled to input ports of the flip-flops F3 and F4. The buffer B2 buffers the data received at the input port and transmits the buffered data to the output port. The buffer B2 is designed for buffering the data received at the data port. Because the received data from the external devices is weakened by the external noises or external resistances, it has to be buffered with more current sizes or higher voltage levels again when the host 500 receives the data.

It is assumed that the host uses the idea of FIG. 3 for transmitting data, which is transmitting the first bit of data at the rising edge of the first period of the clock signal CLK and the second bit of data at the falling edge of the clock signal CLK just right after the rising edge of the first period of the clock signal CLK. When the host 500 has a 2-bit data to transmit to external devices, of which one bit is D0 and the other bit is D1 to transmit, the buffer controller 502 start to transmit the bit D0 to the flip-flop F1 at the rising edge of the first period of the clock signal CLK and the bit D1 to the flip-flop F2 at the falling edge of the clock signal CLK just right after the rising edge of the first period of the clock signal CLK respectively. It is further assumed that both of the flip-flops F1 and F2 are triggered at rising edges. At the rising edge of the first period of the clock signal CLK, the flip-flop F1 transmits the bit D0 to the input port H of the selection device S1. After the rising edge of the first period of the clock signal CLK, there is a half period that the clock signal CLK is high so that the high status of the clock signal CLK enables the selection device S1 to couple the input port H to the output port O. Thus, the bit D0 is transmitted from the flip-flop F1, through the selection device S1, the buffer B1, and the data port, to the external devices. After the falling edge just right after the rising edge of the first period of the clock signal CLK, there is a half period that the clock signal CLK is low so that the low status of the clock signal CLK enables the selection device S1 to couple the input port L to the output port O. Thus, the bit D1 is transmitted from the flip-flop F2, through the selection device S1, the buffer B1, and the data port, to the external devices. Thus, the transmission of a 2-bit data is finished within a period of the clock signal CLK, which is faster than the prior art.

When the host 500 receives a 2-bit data from the external devices, of which one bit is D0 and the other bit is D1, the data are transmitted through the data port to the input ports of the flip-flops F3 and F4. It is assumed that the flip-flops F3 and F4 are triggered at rising edges. At the rising edges of the clock signal CLK, the first bit D0 is transmitted through the flip-flop F3 to the buffer controller 502. At the falling edges of the clock signal CLK, meaning the rising edges of the inverted clock signal ICLK, the second bit D1 is transmitted through the flip-flop F4 to the buffer controller 502. Thus, the receiving of a 2-bit data is finished within a period of the clock signal CLK, which is faster than the prior art.

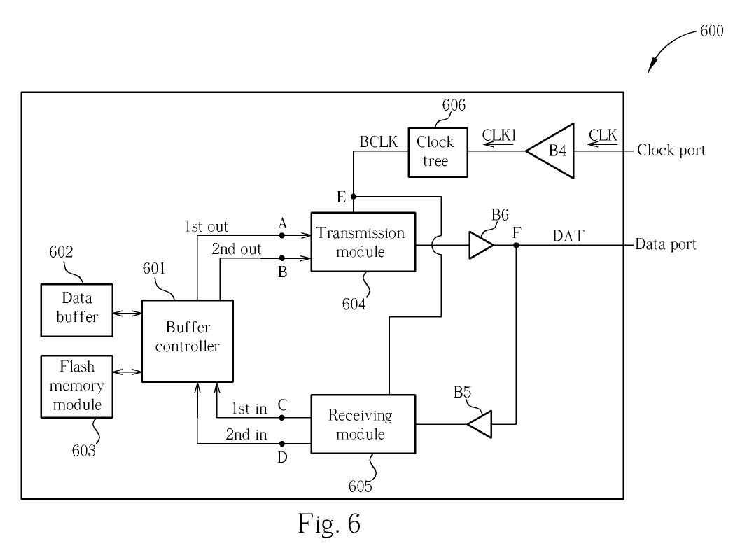

Please refer to FIG. 6. FIG. 6 is a memory card 600 of a first embodiment of the present invention. As shown in FIG. 6, the memory card 600 comprises a buffer controller 601, a data buffer 602, a flash memory module 603, a transmission module 604, a receiving module 605, a clock tree 606, a buffer B4, a buffer B5, and a buffer B6. Besides, the memory card 600 also comprises a clock port to receive a clock signal CLK from an external device, and a data port to exchange the data DAT with the external device.

The buffer B4 is coupled to the clock port for receiving a clock signal CLK and buffering the clock signal CLK. The buffer B4 is designed for buffering the received clock signal CLK at the clock port. Because the received clock signal CLK from the external device is weakened by the external noises or external resistances, it has to be buffered with more current sizes or higher voltage levels again when the memory card 600 receives the clock signal CLK.

The clock tree 606 is coupled to the output port of the buffer B4 for receiving the clock signal ICLK and further buffering the clock signal ICLK to be a buffered clock signal BCLK. Though the clock signal CLK is buffered by the buffer B4, it has to be buffered again for fanning out to many devices of the memory card 600. The clock tree 606 is designed for enabling the clock signal CLK to fan out to more devices without being skewed.

The buffer controller 601 comprises two output ports, two input ports, and two general ports. During transmission, the buffer controller 601 transmits data stored in the flash memory module 603 to the transmission module 604 through the two output ports, and the transmission module 604 accordingly transmits the received data to the data port. During reception, the buffer controller 601 receives data from the receiving module 605 and stores the received data in the flash memory module 603. The output ports of the buffer controller 601 are respectively a first output port and a second output port. The first output port of the buffer controller 601 is designed for during the transmission, the buffer controller 601 transmitting odd bits of the transmitting data, such as the first bit, third bit, fifth bit of the transmitting data, and so on. The second output port of the buffer controller 601 is designed for during the transmission, the buffer controller 601 transmitting even bits of the transmitting data, such as the second bit, fourth bit, sixth bit of the transmitting data, and so on.

The data buffer 602 is coupled to the buffer controller 601 through the first general port of the buffer controller 601. The data buffer 602 is designed for the data ready to be transmitted by the buffer controller 601 or the data ready to be stored in the flash memory module 603.

The flash memory module 603 is coupled to the buffer controller 601 through the second general port of the buffer controller 601. The flash memory module 603 is designed for the buffer controller 601 to store data in or retrieve the stored data out.

The transmission module 604 is coupled between the buffer controller 601 and the data output buffer B6 serving as an interface to transmit bits of data at rising edges and falling edges of the buffered clock BCLK so that the doubled transmission rate is achieved. More particularly, the transmission module 604 is coupled to the first output port and the second output port of the buffer controller 601 for respectively receiving the odd bits and the even bits of the data ready for transmission through the first output port and the second output port of the buffer controller 601. The transmission module 604 is further coupled to the clock tree 606 for receiving the buffered clock signal BCLK so as to synchronize with the external device. The transmission module 604 is further coupled to the data output buffer B6 for transmitting the received odd bits of data at the rising edges of the buffered clock signal BCLK and the received even bits of data at the falling edges of the buffered clock signal BCLK, or transmitting the received odd bits of data at the falling edges of the buffered clock signal BCLK and the received even bits of data at the rising edges of the buffered clock signal BCLK.

The buffer B6 is designed for buffering the data ready to transmit. Because the data is transmitted to the external devices, it has to be buffered with more current sizes or higher voltage levels so as to resist external noises and avoid misreading when the external devices receive the data. Thus the data is buffered by the buffer B6 and transmitted to the data port. The buffer B6 comprises an input port coupled to the output port of the transmission module and an output port coupled to the data port.

The receiving module 605 is coupled between the buffer controller 601 and the data input buffer B5 serving as an interface to receive bits of data at rising edges and falling edges of the buffered clock BCLK so that the doubled transmission rate is achieved. More particularly, the receiving module 605 is coupled to the first input port and the second input port of the buffer controller 601 for respectively receiving the odd bits and the even bits of the data from the data port, transmitting the odd bits of the received data to the buffer controller 601 through the first input port and transmitting the even bits of the received data to the buffer controller 601 through the second input port. The receiving module 605 is further coupled to the clock tree 606 for receiving the buffered clock signal BCLK so as to synchronize with the external device. The receiving module 605 is further coupled to the data input buffer B5 for receiving the odd bits of data at the rising edges of the buffered clock signal BCLK and the even bits of data at the falling edges of the buffered clock signal BCLK, or receiving the odd bits of data at the falling edges of the buffered clock signal BCLK and the even bits of data at the rising edges of the buffered clock signal BCLK.

Besides, the nodes A, B, C, D, E, and F are pointed out in FIG. 6 for the ease of following description. The nodes A, B, C, D, E, and F respectively represent the first output port of the buffer controller 601, the second output port of the buffer controller 601, the first input port of the buffer controller 601, the second input port of the buffer controller 601, the output port of the clock tree 606, and the data port. The further coupling relations of the nodes A, B, C, D, E, and F are described in the previous paragraph and FIG. 6, which are omitted.

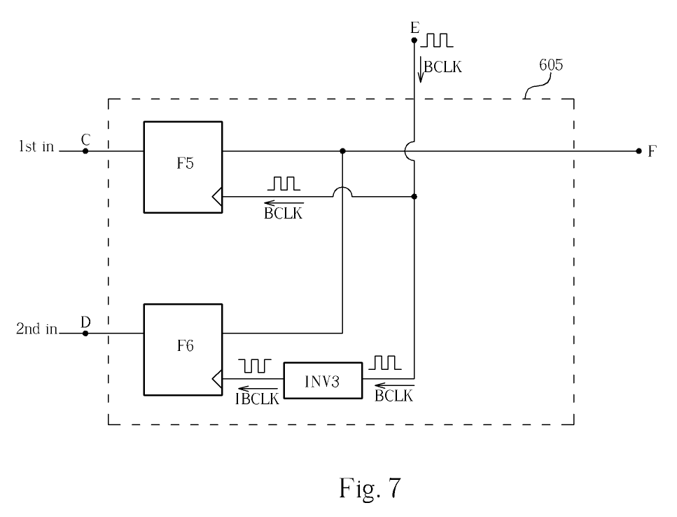

Please refer to FIG. 7. FIG. 7 is a circuit diagram illustrating a receiving module 605 of a first embodiment of the present invention. As shown in FIG. 7, the receiving module 605 comprises two flip-flops F5 and F6, and an inverter INV3. The inverter INV3 is coupled to node E for receiving the buffered clock signal BCLK, accordingly inverting the buffered clock signal BCLK, and generating an inverse clock signal IBCLK. The clock signals BCLK and IBCLK are inverse to each other. The flip-flop F5 comprises an input port coupled to the output port of the buffer B5 for receiving data, an output port for outputting the data received at the input port of the flip-flop F5 to the node C, and a control port coupled to the node E for receiving the clock signal BCLK. The flip-flop F5 outputs the received data according to the signal status on the control port of the flip-flop F5. The flip-flop F6 comprises an input port coupled to the output port of the buffer B5 for receiving data, an output port for outputting the data received at the input port of the flip-flop F5 to the node D, and a control port coupled to the output port of the inverter INV3 for receiving the clock signal IBCLK. The flip-flop F6 outputs the received data according to the signal status on the control port of the flip-flop F6. It is assumed that both of the flip-flops F5 and F6 are triggered at rising edges. When the buffer controller 502 receives a 2-bit data, one bit is D0 and the other bit is D1. The data are transmitted through the data port to the input ports of the flip-flops F3 and F4.

It is assumed that the flip-flops F5 and F6 are triggered at rising edges. When the memory card 600 receives a 2-bit data, one bit is D0 and the other bit is D1. The data are transmitted through the data port to the input ports of the flip-flops F5 and F6. At the rising edges of the clock signal BCLK, the first bit D0 is transmitted through the flip-flop F5 to the buffer controller 601. At the falling edges of the clock signal BCLK, meaning the rising edges of the inverted clock signal IBCLK, the second bit D1 is transmitted through the flip-flop F6 to the buffer controller 601. Thus, the receiving of a 2-bit data is finished within a period of the clock signal BCLK, which is faster than the prior art.

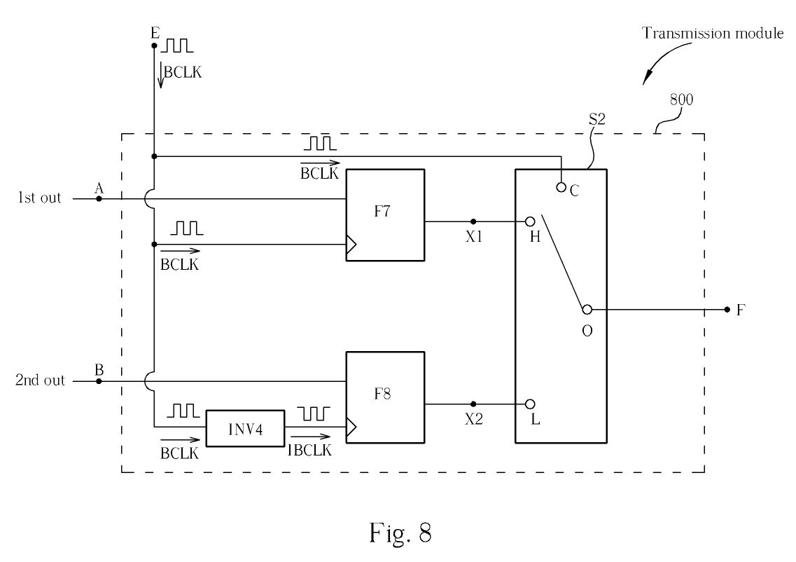

Please refer to FIG. 8. FIG. 8 is a circuit diagram illustrating a transmission module 800 of a first embodiment of the transmission module 604 of the present invention. The transmission module 800 comprises two flip-flops F7 and F8, a selection device S2, an inverter INV4, and a buffer B6. The inverter INV4 is coupled to the output port of the clock tree 606 (node E) for receiving the buffered clock signal BCLK, accordingly inverting the buffered clock signal BCLK, and generating an inverse clock signal IBCLK. The clock signals BCLK and IBCLK are inverse to each other. The flip-flop F7 comprises an input port coupled to the first output port of the buffer controller 601 (node A) to receive the data output from the buffer controller 601, a control port coupled to the output port of the clock tree 606 (node E) to receive the clock signal BCLK, and an output port coupled to the input port H of the selection device S2. At the rising edges of the clock signal BCLK, the flip-flop F7 transmits the data received at the input port to the output port. The flip-flop F8 comprises an input port coupled to the second output port of the buffer controller 601 (node B) to receive the data output from the buffer controller 601, a control port coupled to the inverter INV4 to receive the inverted clock signal IBCLK, and an output port coupled to the input port L of the selection device S2. At the rising edges of the inverted clock signal IBCLK, meaning at the falling edge of the clock signal BCLK, the flip-flop F8 transmits the data received at the input port to the output port. The selection device S2 comprises input ports L and H respectively coupled to the output port of the flip-flop F7 and the output port of the flip-flop F8, a control port C coupled to the output port of the clock tree 606 (node E), and an output port O coupled to the buffer B6. When the clock signal BCLK is high, the selection device S2 couples the input port H to the output port O, and when the clock signal BCLK is low, the selection device S2 couples the input port L to the output port O.

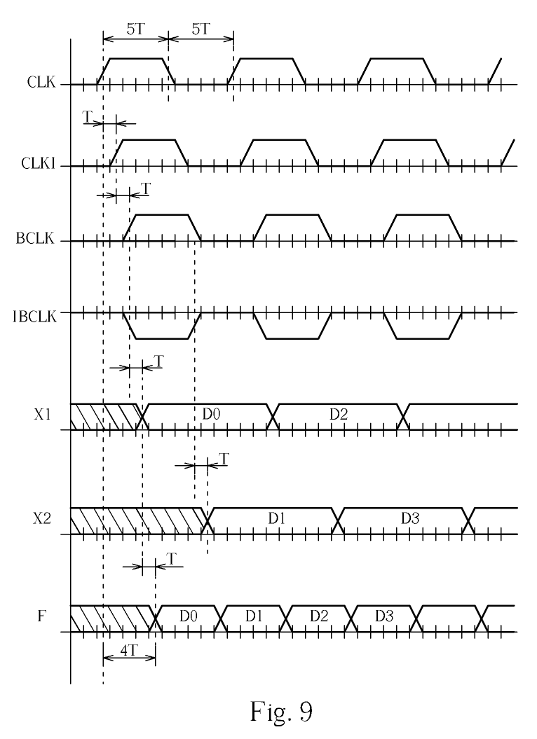

Please refer to FIG. 9. FIG. 9 is a timing diagram illustrating the timing relation of the transmission module 800 when the memory card 600 transmits data. It is assumed that the memory card 600 uses the idea of FIG. 3 for transmitting data, which is transmitting the first bit of data at the rising edge of the first period of the clock signal CLK and the second bit of data at the falling edge of the clock signal CLK just right after the rising edge of the first period of the clock signal CLK. It is further assumed that-a high state extending for a period 5T, and a low state extending for a period 5T. There are delays in the components of the transmission module 800, such as in the clock input buffer B4, the clock tree 606, in the flip-flops F7 and F8, and in the selection device S2. Therefore, it is further assumed that the delay in the clock input buffer B4, the clock tree 606, in the flip-flops F7 and F8, and in the selection device S2, is a period T. When the memory card 600 has a 4-bit data to transmit to external devices, of which the bits of the data respectively are D0, D1, D2, and D3, as shown in the part CLK of FIG. 9, the buffer controller 601 start to transmit the bit D0 to the flip-flop F7 and the bit D1 to the flip-flop F8, and then transmit the bit D2 to the flip-flop F7 and the bit D3 to the flip-flop F8. It is further assumed that both of the flip-flops F7 and F8 are triggered at rising edges. Because control port of the flip-flop F8 is coupled to the inverter INV4, the data is available at the output port of the flip-flop F8 (node X2) according to the clock signal IBCLK. As shown in the part BCLK of FIG. 9, the clock signal CLKI is delayed for a period T than the clock signal CLK, and the clock signal BCLK is delayed for a period T than the clock signal CLKI. Therefore, as shown in the part X1 of FIG. 9, the flip-flop F7 is triggered by the clock signal BCLK after 2 periods T, and because a delay for a period T of the flip-flop F7, the bit D0 is available at the output of the flip-flop F7 (node X1) after 3 periods T. Because control port of the flip-flop F8 is coupled to the output port of the inverter B4, the data is available at the output port of the flip-flop F8 (node X2) according to the clock signal IBCLK. As shown in the part IBCLK of FIG. 9, the clock signal CLKI is delayed for a period T than the clock signal CLK, and the clock signal IBCLK is delayed for a period T than the clock signal CLKI. Therefore, as shown in the part X2 of FIG. 9, the flip-flop F8 is triggered by the clock signal IBCLK after 8 periods T, and because a delay for a period T of the flip-flop F8, the bit D1 is available at the output port of the flip-flop F8 (node X2) after 9 periods T. There are a period T delay between the input port L and the output port of the selection device S2. Consequently, as shown in the part F of FIG. 9, the first bit D0 is available after 4 periods T. In this way, based on the assumption above, the memory card 600 has a delay for 4 periods T when transmitting data.

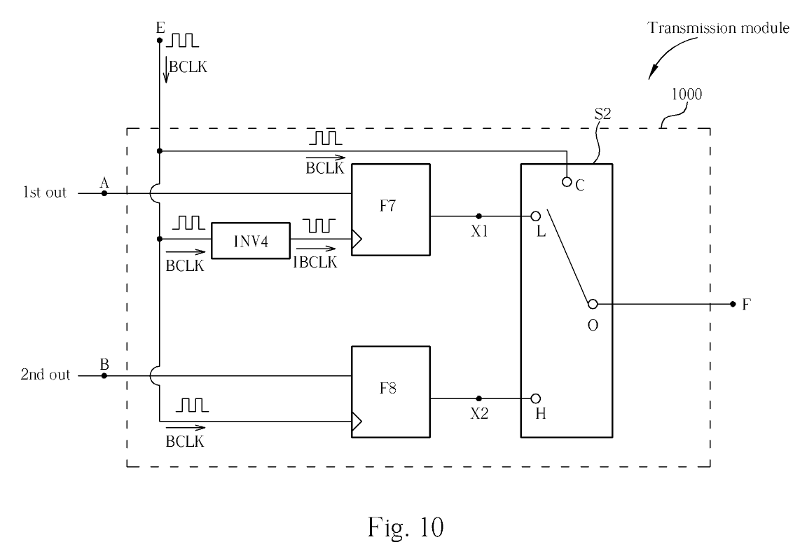

Please refer to FIG. 10. FIG. 10 is a circuit diagram illustrating a transmission module 1000 of a first embodiment of the transmission module 604 of the present invention. The transmission module 1000 comprises two flip-flops F7 and F8, a selection device S2, an inverter INV4, and a buffer B6. The inverter INV4 is coupled to the output port of the clock tree 606 (node E) for receiving the buffered clock signal BCLK, accordingly inverting the buffered clock signal BCLK, and generating an inverse clock signal IBCLK. The clock signals BCLK and IBCLK are inverse to each other. The flip-flop F7 comprises an input port coupled to the first output port of the buffer controller 601 (node A) to receive the data output from the buffer controller 601, a control port coupled to the inverter INV4 to receive the inverted clock signal IBCLK, and an output port coupled to the input port L of the selection device S2. At the rising edges of the inverted clock signal IBCLK, meaning at the falling edge of the clock signal BCLK, the flip-flop F7 transmits the data received at the input port to the output port. The flip-flop F8 comprises an input port coupled to the second output port of the buffer controller 601 (node A) to receive the data output from the buffer controller 601, a control port coupled to the output port of the clock tree 606 (node E) to receive the clock signal BCLK, and an output port coupled to the input port H of the selection device S2. At the rising edges of the clock signal BCLK, the flip-flop F8 transmits the data received at the input port to the output port. The selection device S2 comprises input ports L and H respectively coupled to the output port of the flip-flop F7 and the output port of the flip-flop F8, a control port C coupled to the output port of the clock tree 606 (node E), and an output port O coupled to the buffer B6. When the clock signal BCLK is high, the selection device S2 couples the input port H to the output port O, and when the clock signal BCLK is low, the selection device S2 couples the input port L to the output port O.

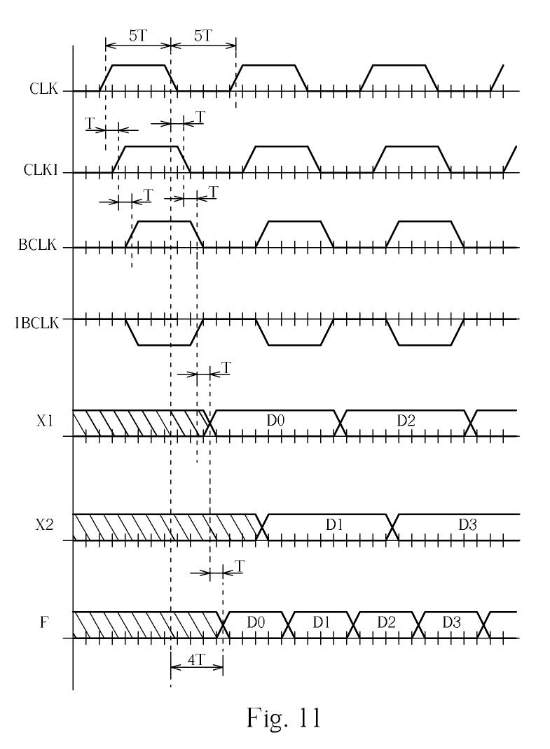

Please refer to FIG. 11. FIG. 11 is a timing diagram illustrating the timing relation of the transmission module 1000 when the memory card 600 transmits data. It is assumed that the memory card 600 uses the idea of FIG. 4 for transmitting data, which is transmitting the first bit of data at the falling edge of the first period of the clock signal CLK and the second bit of data at the rising edge of the clock signal CLK just right after the rising edge of the first period of the clock signal CLK. It is further assumed that a high state extending for a period 5T, and a low state extending for a period 5T. There are delays in the components of the transmission module 1000, such as in the clock tree 606, in the flip-flops F7 and F8, and in the selection device S2. Therefore, it is further assumed that the delay in the clock input buffer B4, the clock tree 606, in the flip-flops F7 and F8, and in the selection device S2, is a period T. When the memory card 600 has a 4-bit data to transmit to external devices, of which the bits of the data respectively are D0, D1, D2, and D3, as shown in the part CLK of FIG. 11, the buffer controller 601 start to transmit the bit D0 to the flip-flop F7, and the bit D1 to the flip-flop F8, and then transmit the bit D2 to the flip-flop F7 and the bit D3 to the flip-flop F8. It is further assumed that both of the flip-flops F7 and F8 are triggered at rising edges. Because control port of the flip-flop F7 is coupled to the inverter INV4, the data is available at the output port of the flip-flop F7 (node X1) according to the clock signal IBCLK. As shown in the part BCLK of FIG. 11, the clock signal CLKI is delayed for a period T than the clock signal CLK, and the clock signal IBCLK is delayed for a period T than the clock signal CLKI. Therefore, as shown in the part X1 of FIG. 11, the flip-flop F7 is triggered by the clock signal IBCLK after 2 periods T, and because a delay for a period T of the flip-flop F7, the bit D0 is available after 3 periods T. Because control port of the flip-flop F8 is coupled to the output port of the clock tree 606 (node E), the data is available at the output port of the flip-flop F8 (node X2) according to the clock signal BCLK. As shown in the part BCLK of FIG. 10, the clock signal CLKI is delayed for a period T than the clock signal CLK, and the clock signal BCLK is delayed for a period T than the clock signal CLKI. Therefore, as shown in the part X2 of FIG. 11, the flip-flop F8 is triggered by the clock signal BCLK after 7 periods T, and because a delay for a period T of the flip-flop F8, the bit D1 is available after 8 periods T. There are a period T delay between the input port L and the output port of the selection device S2. Consequently, as shown in the part F of FIG. 11, the first bit D0 is available after 4 periods T. In this way, based on the assumption above, the memory card 600 has a delay for 4 periods T when transmitting data.

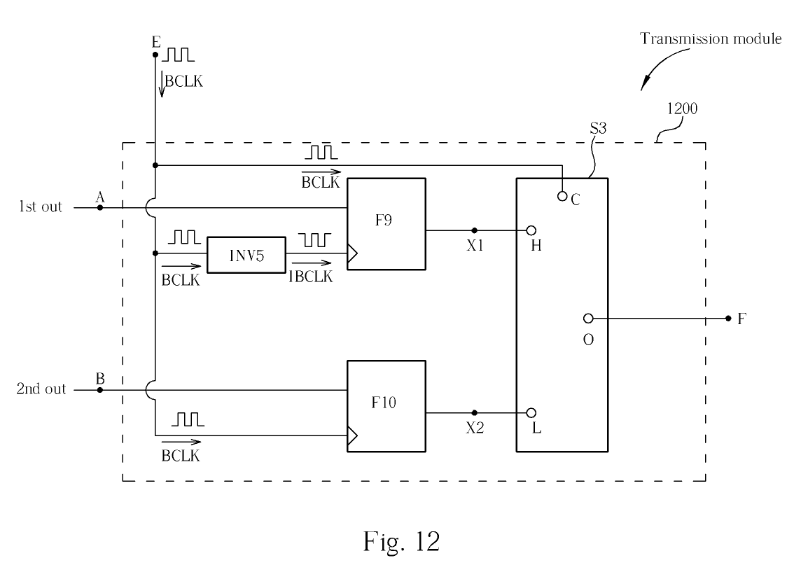

Please refer to FIG. 12. FIG. 12 is a circuit diagram illustrating a transmission module 1200 of a second embodiment of the transmission module 604 of the present invention. The transmission module 1200 comprises two flip-flops F9 and F10, a selection device S3, an inverter INV5. The inverter INV5 is coupled to the output port of the clock tree 606 (node E) for receiving the buffered clock signal BCLK, accordingly inverting the buffered clock signal BCLK, and generating an inverse clock signal IBCLK. The clock signals BCLK and IBCLK are inverse to each other. The flip-flop F9 comprises an input port coupled to the first output port of the buffer controller 601 (node A) to receive the data output from the buffer controller 601, a control port coupled to the inverter INV5 to receive the inverted clock signal IBCLK, and an output port coupled to the input port H of the selection device S3. At the rising edges of the inverted clock signal IBCLK, meaning at the falling edge of the clock signal BCLK, the flip-flop F9 transmits the data received at the input port to the output port. The flip-flop F10 comprises an input port coupled to the second output port of the buffer controller 601 (node B) to receive the data output from the buffer controller 601, a control port coupled to the output port of the clock tree 606 (node E) to receive the clock signal BCLK, and an output port coupled to the input port L of the selection device S3. At the rising edges of the clock signal IBCLK, the flip-flop F10 transmits the data received at the input port to the output port. The selection device S3 comprises input ports L and H respectively coupled to the output port of the flip-flop F10 and the output port of the flip-flop F9, a control port C coupled to the output port of the clock tree 606 (node E), and an output port o coupled to the buffer B7. When the clock signal BCLK is high, the selection device S3 couples the input port H to the output port O, and when the clock signal BCLK is low, the selection device S3 couples the input port L to the output port O.

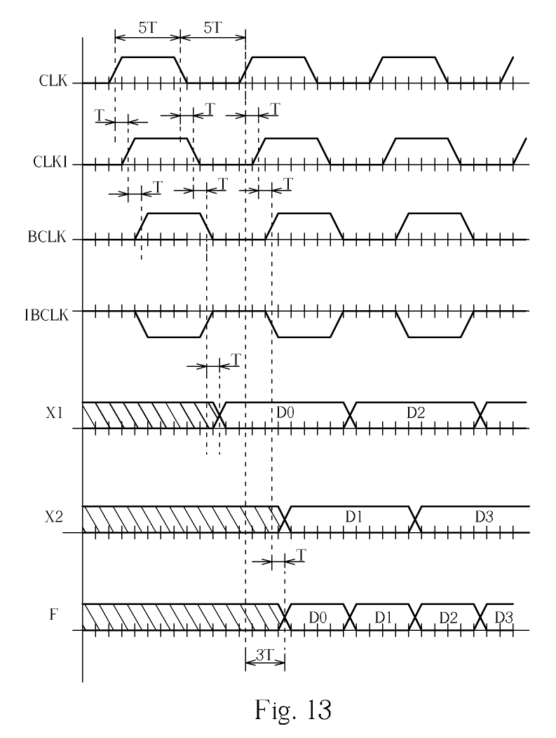

Please refer to FIG. 13. FIG. 13 is a timing diagram illustrating the timing relation of the transmission module 1200 when the memory card 600 transmits data. It is assumed that the memory card 600 uses the idea of FIG. 3 for transmitting data, which is transmitting the first bit of data at the rising edge of the first period of the clock signal CLK and the second bit of data at the falling edge of the clock signal CLK just right after the rising edge of the first period of the clock signal CLK. It is further assumed that a high state extending for a period 5T, and a low state extending for a period 5T. There are delays in the components of the transmission module 1200, such as in the clock input buffer B4, the clock tree 606, in the flip-flops F9 and F10, and in the selection device S3. Therefore, it is further assumed that the delay in the clock input buffer B4, the clock tree 606, in the flip-flops F9 and F10, and in the selection device S3, is a period T. When the memory card 600 has a 4-bit data to transmit to external devices, of which the bits of the data respectively are D0, D1, D2, and D3 and the bit D1 to the flip-flop F10, and then transmits the bit D2 to the flip-flop F9 and the bit D3 to the flip-flop F10. It is further assumed that both of the flip-flops F9 and F10 are triggered at rising edges. Because control port of the flip-flop F9 is coupled to the output port of the inverter INV5, the data is available at the output port of the flip-flop F9 (node X1) according to the clock signal IBCLK. As shown in the part BCLK of FIG. 13, the clock signal BCLK is delayed for 2 periods T than the clock signal CLK, and thus the clock signal IBCLK is also delayed for the same period than the clock signal CLK. Therefore, as shown in the part X1 of FIG. 13, the flip-flop F9 is triggered by the clock signal BCLK after 2 periods T, and because a delay for a period T of the flip-flop F9, the bit D0 is available after 3 periods T. Because control port of the flip-flop F10 is coupled to the clock tree 606 (node E), the data is available at the output port of the flip-flop F10 (node X2) according to the clock signal BCLK. As shown in the part BCLK of FIG. 13, the clock signal BCLK is delayed for 2 periods T than the clock signal CLK. Therefore, as shown in the part X2 of FIG. 12, the flip-flop F10 is triggered by the clock signal BCLK after 7 periods T, and because a delay for a period T of the flip-flop F10, the bit D1 is available after 8 periods T. Because control port of the selection device S3 is coupled to the output port of the clock tree 606 (node E), the data on the input port L and the data on the input port H is available at the output port of the selection device S3 according to the clock signal BCLK. As shown in the part BCLK of FIG. 13 and the part S3 of FIG. 13, the clock signal BCLK is delayed for 2 periods T than the clock signal CLK and the selection device S3 is further delayed a period T than the clock signal BCLK. Consequently, as shown in the part F of FIG. 13, the first bit D0 is available after 3 periods T. In this way, based on the assumption above, the memory card 600 has a delay for 3 periods T when transmitting data.

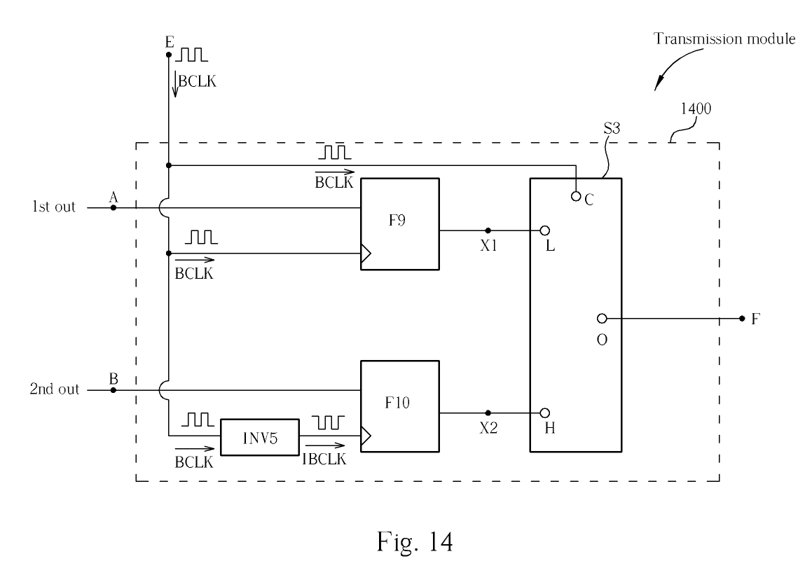

Please refer to FIG. 14. FIG. 14 is a circuit diagram illustrating a transmission module 1400 of a second embodiment of the transmission module 604 of the present invention. The transmission module 1400 comprises two flip-flops F9 and F10, a selection device S3, an inverter INV5. The inverter INV5 is coupled to the output port of the clock tree 606 (node E) for receiving the buffered clock signal BCLK, accordingly inverting the buffered clock signal BCLK, and generating an inverse clock signal IBCLK. The clock signals BCLK and IBCLK are inverse to each other. The flip-flop F9 comprises an input port coupled to the first output port of the buffer controller 601 (node A) to receive the data output from the buffer controller 601, a control port coupled to the output port of the clock tree 606 (node E) to receive the clock signal BCLK, and an output port coupled to the input port L of the selection device S3. At the rising edges of the clock signal BCLK, the flip-flop F9 transmits the data received at the input port to the output port. The flip-flop F10 comprises an input port coupled to the second output port of the buffer controller 601 (node B) to receive the data output from the buffer controller 601, a control port coupled to the inverter INV5 to receive the inverted clock signal IBCLK, and an output port coupled to the input port H of the selection device S3. At the rising edges of the inverted clock signal IBCLK, meaning at the falling edge of the clock signal BCLK, the flip-flop F10 transmits the data received at the input port to the output port. The selection device S3 comprises input ports L and H respectively coupled to the output port of the flip-flop F10 and the output port of the flip-flop F9, a control port C coupled to the output port of the clock tree 606 (node E), and an output port O coupled to the buffer B7. When the clock signal BCLK is high, the selection device S3 couples the input port H to the output port O, and when the clock signal BCLK is low, the selection device S3 couples the input port L to the output port O.

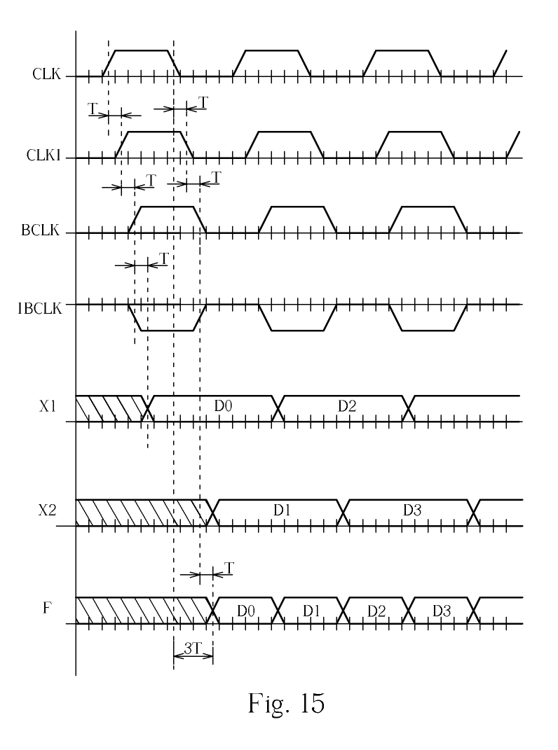

Please refer to FIG. 15. FIG. 15 is a timing diagram illustrating the timing relation of the transmission module 1400 when the memory card 600 transmits data. It is assumed that the memory card 600 uses the idea of FIG. 4 for transmitting data, which is transmitting the first bit of data at the falling edge of the first period of the clock signal CLK and the second bit of data at the rising edge of the clock signal CLK just right after the rising edge of the first period of the clock signal CLK. It is further assumed that a high state extending for a period 5T, and a low state extending for a period 5T. There are delays in the components of the transmission module 1400, such as in the clock input buffer B4, the clock tree 606, in the flip-flops F9 and F10, and in the selection device S3. Therefore, it is further assumed that the delay in the clock input buffer B4, the clock tree 606, in the flip-flops F9 and F10, and in the selection device S3, is a period T. When the memory card 600 has a 4-bit data to transmit to external devices, of which the bits of the data respectively are D0, D1, D2, and D3, the buffer controller 601 start to transmit the bit D0 to the flip-flop F9 and the bit D1 to the flip-flop F10 at the first falling edge of the clock signal CLK, and then transmits the bit D2 to the flip-flop F9 and the bit D3 to the flip-flop F10. It is further assumed that both of the flip-flops F9 and F10 are triggered at rising edges. Because control port of the flip-flop F9 is coupled to the clock tree 606 (node E), the data is available at the output port of the flip-flop F9 (node X1) according to the clock signal BCLK. As shown in the part BCLK of FIG. 15, the clock signal BCLK is delayed for 2 periods T than the clock signal CLK. Therefore, as shown in the part X1 of FIG. 15, the flip-flop F9 is triggered by the clock signal BCLK after 2 periods T, and because a delay for a period T of the flip-flop F9, the bit D0 is available after 3 periods T. Because control port of the flip-flop F10 is coupled to the output port of the inverter INV5, the data is available at the output port of the flip-flop F10 (node X2) according to the clock signal IBCLK. As shown in the part BCLK of FIG. 15, the clock signal BCLK is delayed for 2 periods T than the clock signal CLK, and thus the clock signal IBCLK is also delayed for the same period than the clock signal CLK. Therefore, as shown in the part X2 of FIG. 15, the flip-flop F10 is triggered by the clock signal IBCLK after 7 periods T, and because a delay for a period T of the flip-flop F10, the bit D1 is available after 8 periods T. Because control port of the selection device S3 is coupled to the output port of the clock tree 606 (node E), the data on the input port L and the data on the input port H is available at the output port of the selection device S3 according to the clock signal BCLK. As shown in the part BCLK of FIG. 15 and the part S3 of FIG. 15, the clock signal BCLK is delayed for 2 periods T than the clock signal CLK and the selection device S3 is further delayed a period T than the clock signal BCLK. Consequently, as shown in the part F of FIG. 15, the first bit D0 is available after 3 periods T. In this way, based on the assumption above, the memory card 600 has a delay for 3 periods T when transmitting data.

According to FIG. 13 and FIG. 15, it is understood that when the memory card 600 adapts the transmission module 1400 as the interface, it is better to use the transmission module 800 because of the shorter delay time.

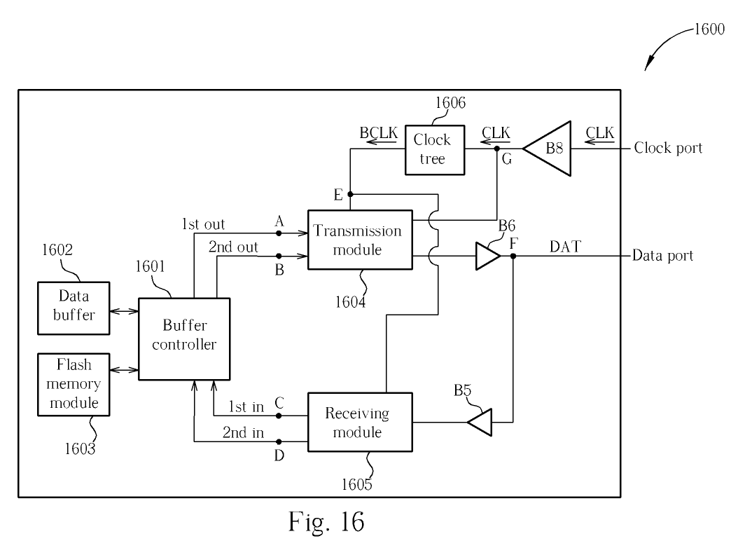

Please refer to FIG. 16. FIG. 16 is a diagram illustrating a memory card 1600 of a second embodiment of the present invention. All components in FIG. 16 are the same as those in FIG. 6 so that the related descriptions are omitted. The difference between FIG. 6 and FIG. 16 is that the transmission module 1604 is further coupled to the buffer B8 (node G). In this way, the clock signal CLKI is directly input into the transmission module 1604.

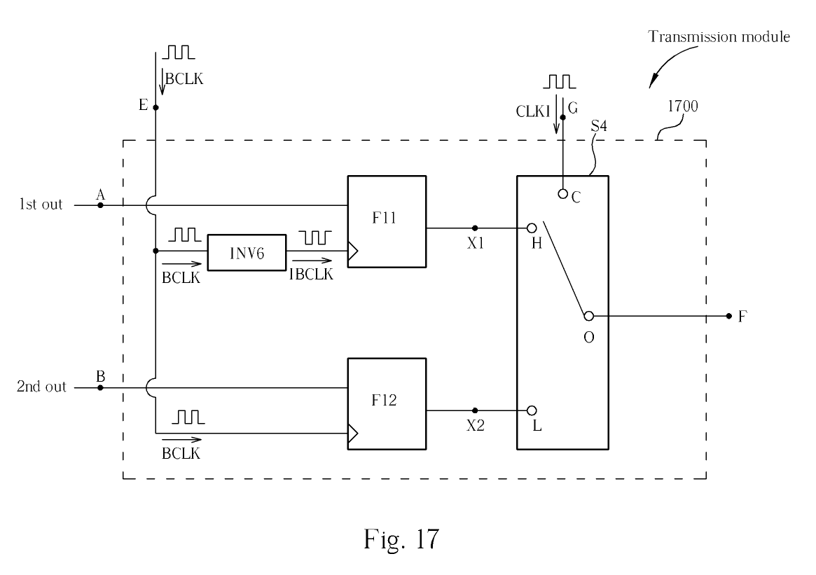

Please refer to FIG. 17. FIG. 17 is a circuit diagram illustrating a transmission module 1700 of a first embodiment of the flash memory card 1600 of the present invention. The components in FIG. 17 and the coupling relations are similar to FIG. 12. The only difference between the transmission module 1700 and the transmission module 1200 is that in the transmission module 1700, the control port of the selection device S4 is directly coupled to the buffer B8 (node G) instead of the output port of the clock tree 1606 for receiving the clock signal CLK. Therefore, it is the clock signal CLK that controls the internal coupling of the selection device S4 so that the delay of the selection device S4 is shorter than the delay of the selection device S2 of the transmission module 1200. Consequently, the flash memory card 1600 provides data transmission with shorter delay time by utilizing the transmission module 1700. Therefore, the flash memory card 1600 can use the transmission module 1700 and the idea of FIG. 3 to earn the shortest delay time.

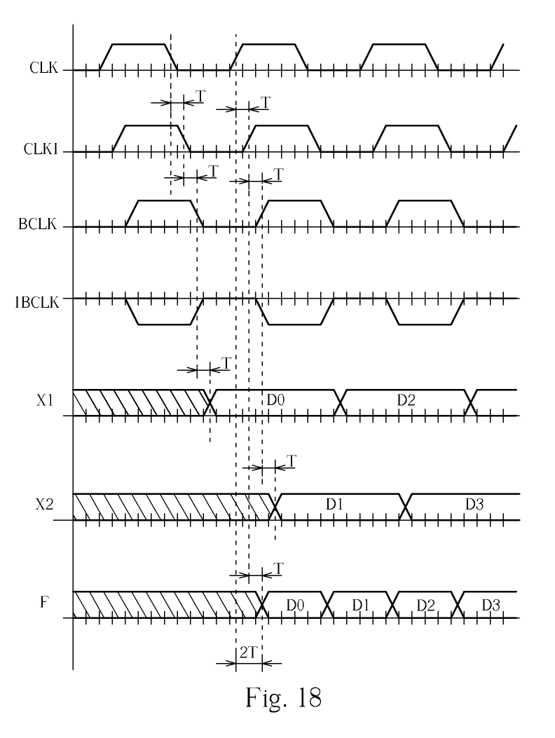

Please refer to FIG. 18. FIG. 18 is a timing diagram illustrating the timing relation of the transmission module 1700 when the memory card 1600 transmits data. It is assumed that the memory card 1600 uses the idea of FIG. 3 for transmitting data, which is transmitting the first bit of data at the rising edge of the first period of the clock signal CLK and the second bit of data at the falling edge of the clock signal CLK just right after the rising edge of the first period of the clock signal CLK. It is further assumed that a high state extending for a period 5T, and a low state extending for a period 5T. There are delays in the components of the transmission module 1700, such as in the clock input buffer B8, the clock tree 1406, in the flip-flops F11 and F12, and in the selection device S4. Therefore, it is further assumed that the delay in the clock input buffer B8, the clock tree 1606, in the flip-flops F11 and F12, and in the selection device S4, is a period T. When the memory card 1600 has a 4-bit data to transmit to external devices, of which the bits of the data respectively are D0, D1, D2, and D3, the buffer controller 1401 start to transmit the bit D0 to the flip-flop F11, and the bit D1 to the flip-flop F12, and then transmits the bit D2 to the flip-flop F11, and the bit D3 to the flip-flop F12. It is further assumed that both of the flip-flops F11 and F12 are triggered at rising edges. Because control port of the flip-flop F11 is coupled to the output port of the inverter INV6, the data is available at the output port of the flip-flop F11 (node X1) according to the clock signal IBCLK. As shown in the part BCLK of FIG. 18, the clock signal BCLK is delayed for 2 periods T than the clock signal CLK, and thus the clock signal IBCLK is also delayed for the same period than the clock signal CLK. Therefore, as shown in the part X1 of FIG. 18, the flip-flop F11 is triggered by the clock signal BCLK after 2 periods T, and because a delay for a period T of the flip-flop F11, the bit D0 is available after 3 periods T. Because control port of the flip-flop F12 is coupled to the clock tree 1406 (node E), the data is available at the output port of the flip-flop F12 (node X2) according to the clock signal BCLK. As shown in the part BCLK of FIG. 18, the clock signal BCLK is delayed for 2 periods T than the clock signal CLK. Therefore, as shown in the part X2 of FIG. 18, the flip-flop F12 is triggered by the clock signal BCLK after 7 periods T, and because a delay for a period T of the flip-flop F12, the bit D1 is available after 8 periods T. Because control port of the selection device S4 is coupled to the output port of the clock buffer B8, the data on the input port L and the data on the input port H is available at the output port of the selection device S4 according to the clock signal BCLK. As shown in the part BCLK of FIG. 18 and the part S4 of FIG. 18, the clock signal CLKI is delayed for a period T than the clock signal CLK and the selection device S4 is further delayed a period T than the clock signal BCLK. Consequently, as shown in the part F of FIG. 18, the first bit D0 is available after 2 periods T. In this way, based on the assumption above, the memory card 1600 has a delay for 2 periods T when transmitting data.

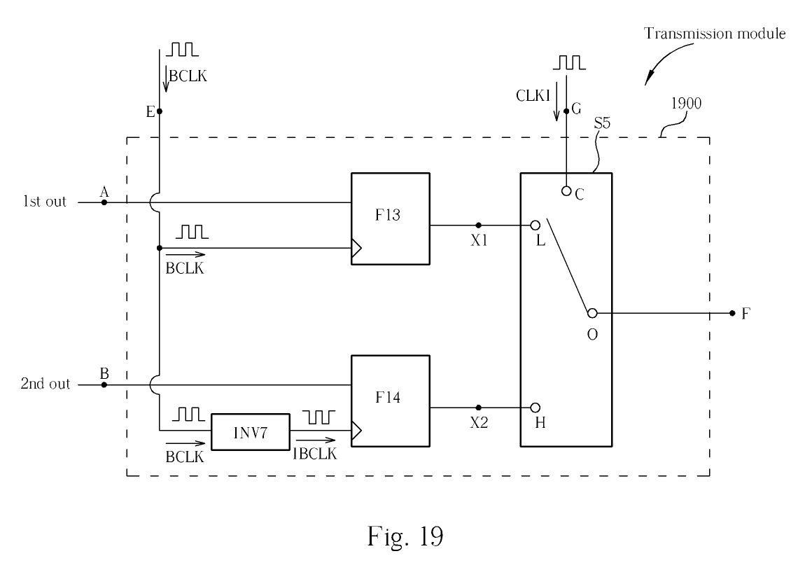

Please refer to FIG. 19. FIG. 16 is a circuit diagram illustrating a transmission module 1900 of a second embodiment of the flash memory card 1600 of the present invention. The components in FIG. 19 and the coupling relations are similar to FIG. 14. The only difference between the transmission module 1900 and the transmission module 1400 is that in the transmission module 1900, the control port of the selection device S5 is directly coupled to the buffer B8 (node G) instead of the output port of the clock tree 1606 for receiving the clock signal CLK. Therefore, it is the clock signal CLK that controls the internal coupling of the selection device S5 so that the delay of the selection device S5 is shorter than the delay of the selection device S3 of the transmission module 1000. Consequently, the memory card 1600 provides data transmission with shorter delay time by utilizing the transmission module 1900. Therefore, the flash memory card 1600 can use the transmission module 1900 and the idea of FIG. 4 to earn the shortest delay time.

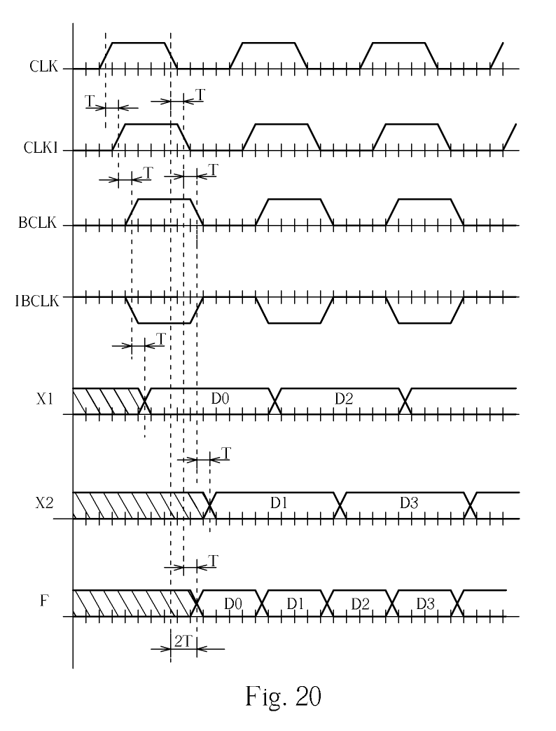

Please refer to FIG. 20. FIG. 20 is a timing diagram illustrating the timing relation of the transmission module 1900 when the memory card 1600 transmits data. It is assumed that the memory card 1600 uses the idea of FIG. 4 for transmitting data, which is transmitting the first bit of data at the falling edge of the first period of the clock signal CLK and the second bit of data at the rising edge of the clock signal CLK just right after the rising edge of the first period of the clock signal CLK. It is further assumed that a high state extending for a period 5T, and a low state extending for a period 5T. There are delays in the components of the transmission module 1900, such as in the clock input buffer B8, the clock tree 1606, in the flip-flops F13 and F14, and in the selection device S5. Therefore, it is further assumed that the delay in the clock input buffer B8, the clock tree 1606, in the flip-flops F13 and F14, and in the selection device S5, is a period T. When the memory card 1400 has a 4-bit data to transmit to external devices, of which the bits of the data respectively are D0, D1, D2, and D3, the buffer controller 1401 start to transmit the bit D0 to the flip-flop F13 and the bit D1 to the flip-flop F14 at the first falling edge of the clock signal CLK, and then transmits the bit D2 to the flip-flop F13 and the bit D3 to the flip-flop F14. It is further assumed that both of the flip-flops F13 and F14 are triggered at rising edges. Because control port of the flip-flop F13 is coupled to the clock tree 1606 (node E), the data is available at the output port of the flip-flop F13 (node X1) according to the clock signal BCLK. As shown in the part BCLK of FIG. 20, the clock signal BCLK is delayed for 2 periods T than the clock signal CLK. Therefore, as shown in the part X1 of FIG. 20, the flip-flop F13 is triggered by the clock signal BCLK after 2 periods T, and because a delay for a period T of the flip-flop F13, the bit D0 is available after 3 periods T. Because control port of the flip-flop F14 is coupled to the output port of the inverter INV7, the data is available at the output port of the flip-flop F14 (node X2) according to the clock signal IBCLK. As shown in the part BCLK of FIG. 20, the clock signal BCLK is delayed for 2 periods T than the clock signal CLK, and thus the clock signal IBCLK is also delayed for the same period than the clock signal CLK. Therefore, as shown in the part X2 of FIG. 20, the flip-flop F14 is triggered by the clock signal IBCLK after 7 periods T, and because a delay for a period T of the flip-flop F14, the bit D1 is available after 8 periods T. Because control port of the selection device S5 is coupled to the output port of the clock tree 1406 (node E), the data on the input port L and the data on the input port H is available at the output port of the selection device S5 according to the clock signal BCLK. As shown in the part BCLK of FIG. 20 and the part S5 of FIG. 20, the clock signal CLKI is delayed for a period T than the clock signal CLK and the selection device S5 is further delayed a period T than the clock signal BCLK. Consequently, as shown in the part F of FIG. 20, the first bit D0 is available after 2 periods T. In this way, based on the assumption above, the memory card 1600 has a delay for 2 periods T when transmitting data.

According to FIG. 19 and FIG. 20, it is understood that when the memory card 1600 adapts the transmission module 1700 and the transmission module 1900 as the interface, it is better to use the memory card 600 because of the shorter delay time.

To sum up, the present invention provides a flash memory system with doubled data transmission rate and raise the efficiency of the data transmission between the host and the memory card of the flash memory system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for data transmission with higher transmission rate, comprising:
transmitting a first set of data at a rising edge of a clock signal; and
transmitting a second set of data at a falling edge immediately after the rising edge of the clock signal.

2. A method for data transmission with higher transmission rate, comprising:
transmitting a first set of data at a falling edge of a clock signal; and
transmitting a second set of data at a rising edge immediately after the falling edge of the clock signal.

3. A host with higher transmission rate comprising:
a clock port;
a data port;
a processor comprising a data bus port for transmitting a command;
a buffer controller comprising:
a data bus port coupled to the data bus port of the processor for receiving the command;
a first input port for receiving odd sets of data;
a second input port for receiving even sets of data;
a first output port for transmitting odd sets of data; and
a second output port for transmitting even sets of data;
an oscillator for outputting a clock signal;
a transmission module coupled between the buffer controller, the oscillator, and the data port for transmitting data from the buffer to the data port according to the clock signal; and
a receiving module coupled between the buffer controller, the oscillator, and the data port for receiving data from the data port and transmitting the received data to the buffer controller according to the clock signal.

4. The host of claim 3 further comprising a data buffer coupled to the buffer controller for data buffering.

5. The host of claim 3 wherein the transmission module comprises:
a selection device comprising:
a high input port;
a low input port;
a control port coupled to the oscillator for receiving the clock signal; and
an output port;
wherein the selection device couples the high input port to the output port when the clock signal is high; and the selection device couples the low input port to the output port when the clock signal is low;
an inverter coupled to the oscillator for inverting the clock signal and generating an inverted clock signal;
a first flip-flop comprising:
an input port coupled to a first output port of the buffer controller;
an output port coupled to the high input port of the selection device; and
a control port coupled to the oscillator for receiving the clock signal; and
a second flip-flop comprising:
an input port coupled to a second output port of the buffer controller;
an output port coupled to the low input port of the selection device; and
a control port coupled to the inverter for receiving the inverted clock signal.

6. The host of claim 3 wherein the receiving module comprises:
an inverter coupled to the oscillator for inverting the clock signal and generating an inverted clock signal;
a first flip-flop comprising:
an input port coupled to the data port;
an output port coupled to a first input port of the buffer controller; and
a control port coupled to the oscillator for receiving the clock signal; and
a second flip-flop comprising:
an input port coupled to the data port;
an output port coupled to a second input port of the buffer controller; and
a control port coupled to the inverter for receiving the inverted clock signal.

7. A flash memory card with higher transmission rate comprising:
a data port;
a clock port for receiving a clock signal;
a clock tree coupled to the clock port for buffering the clock signal and accordingly generating a buffered clock signal;
a buffer controller comprising:
a first input port for receiving odd sets of data;
a second input port for receiving even sets of data;
a first output port for transmitting odd sets of data; and
a second output port for transmitting even sets of data;
a transmission module coupled to the buffer controller, the clock tree, and the data port for transmitting data according to rising edges and falling edges of the buffered clock signal;
a receiving module coupled to the buffer controller, the clock tree, and the data for receiving data according to rising edges and falling edges of the buffered clock signal; and
a flash memory storage device coupled to the buffer controller for storing data.

8. The flash memory card of claim 7 further comprising a data buffer coupled to the buffer controller for data buffering.

9. The flash memory card of claim 7 wherein the transmission module comprises:
a selection device comprising:
a high input port;
a low input port;
a control port coupled to the clock tree for receiving the buffered clock signal; and
an output port;
wherein the selection device couples the high input port to the output port when the received buffered clock signal is high, and the selection device couples the low input port to the output port when the received buffered clock signal is low;
an inverter coupled to the clock tree for inverting the buffered clock signal and generating an inverted buffered clock signal;
a first flip-flop comprising:
an input port coupled to a first output port of the buffer controller;
an output port coupled to the high input port of the selection device; and
a control port coupled to the clock tree for receiving the buffered clock signal; and
a second flip-flop comprising:
an input port coupled to the second output port of the buffer controller;
an output port coupled to the low input port of the selection device; and
a control port coupled to the inverter for receiving the inverted buffered clock signal.

10. The flash memory card of claim 7 wherein the transmission module comprises:
a selection device comprising:
a high input port;
a low input port;
a control port coupled to the clock tree for receiving the buffered clock signal; and
an output port;
wherein the selection device couples the high input port to the output port when the received buffered clock signal is high, and the selection device couples the low input port to the output port when the received buffered clock signal is low;
an inverter coupled to the clock port for inverting the buffered clock signal and generating an inverted buffered clock signal;
a first flip-flop comprising:
an input port coupled to a first output port of the buffer controller;
an output port coupled to the low input port of the selection device; and
a control port coupled to the inverter for receiving the inverted buffered clock signal; and
a second flip-flop comprising:
an input port coupled to the second output port of the buffer controller;
an output port coupled to the high input port of the selection device; and
a control port coupled to the clock tree for receiving the buffered clock signal.

11. The flash memory card of claim 7 wherein the receiving module comprises:
an inverter coupled to the clock tree for inverting the buffered clock signal and generating an inverted buffered clock signal;
a first flip-flop comprising:
an input port coupled to the data port;
an output port coupled to a first input port of the buffer controller; and
a control port coupled to the clock tree for receiving the buffered clock signal; and
a second flip-flop comprising:
an input port coupled to the data port;
an output port coupled to a second input port of the buffer controller; and
a control port coupled to the inverter for receiving the inverted buffered clock signal.

12. The flash memory card of claim 7 wherein the receiving module comprises:
an inverter coupled to the clock tree for inverting the buffered clock signal and generating an inverted buffered clock signal;
a first flip-flop comprising:
an input port coupled to the data port;
an output port coupled to a first input port of the buffer controller; and
a control port coupled to the inverter for receiving the inverted buffered clock signal; and
a second flip-flop comprising:
an input port coupled to the data port;
an output port coupled to a second input port of the buffer controller; and
a control port coupled to the clock tree for receiving the buffered clock signal.

13. The flash memory card of claim 7 wherein the transmission module comprises:
a selection device comprising:
a high input port;
a low input port;
a control port coupled to the clock tree for receiving the buffered clock signal; and
an output port;
wherein the selection device couples the high input port to the output port when the received buffered clock signal is high, and the selection device couples the low input port to the output port when the received buffered clock signal is low;
an inverter coupled to the clock tree for inverting the buffered clock signal and generating an inverted buffered clock signal;
a first flip-flop comprising:
an input port coupled to a first output port of the buffer controller;
an output port coupled to the high input port of the selection device; and
a control port coupled to the inverter for receiving the inverted buffered clock signal; and
a second flip-flop comprising:
an input port coupled to the second output port of the buffer controller;
an output port coupled to the low input port of the selection device; and
a control port coupled to the clock tree for receiving the buffered clock signal.

14. The flash memory card of claim 7 wherein the transmission module comprises:
a selection device comprising:
a high input port;
a low input port;
a control port coupled to the clock tree for receiving the buffered clock signal; and
an output port;
wherein the selection device couples the high input port to the output port when the received buffered clock signal is high, and the selection device couples the low input port to the output port when the received buffered clock signal is low;
an inverter coupled to the clock port for inverting the buffered clock signal and generating an inverted buffered clock signal;
a first flip-flop comprising:
an input port coupled to a first output port of the buffer controller;
an output port coupled to the low input port of the selection device; and
a control port coupled to the clock tree for receiving the buffered clock signal; and
a second flip-flop comprising:
an input port coupled to the second output port of the buffer controller;
an output port coupled to the high input port of the selection device; and
a control port coupled to the inverter for receiving the inverted buffered clock signal.

15. A flash memory card with higher transmission rate comprising:
a data port;
a clock port for receiving a clock signal;
a buffer controller comprising:
a first input port for receiving odd sets of data;
a second input port for receiving even sets of data;
a first output port for transmitting odd sets of data; and
a second output port for transmitting even sets of data;
a transmission module coupled to the buffer controller, the clock port, the clock tree and the data port for transmitting data according to rising edges and falling edges of the clock signal;
a receiving module coupled to the buffer controller, the clock tree, and the data for receiving data according to rising edges and falling edges of the buffered clock signal; and
a flash memory storage device coupled to the buffer controller for storing data.

16. The flash memory card of claim 15 further comprising a data buffer coupled to the buffer controller for data buffering.

17. The flash memory card of claim 15 wherein the transmission module comprises:
a selection device comprising:
a high input port;
a low input port;
a control port coupled to the clock port for receiving the clock signal; and
an output port;
wherein the selection device couples the high input port to the output port when the received clock signal is high, and the selection device couples the low input port to the output port when the received clock signal is low;
an inverter coupled to the clock tree for inverting the buffered clock signal and generating an inverted buffered clock signal;
a first flip-flop comprising:
an input port coupled to a first output port of the buffer controller;
an output port coupled to the high input port of the selection device; and
a control port coupled to the clock tree for receiving the buffered clock signal; and
a second flip-flop comprising:
an input port coupled to the second output port of the buffer controller;
an output port coupled to the low input port of the selection device; and
a control port coupled to the inverter for receiving the inverted buffered clock signal.

18. The flash memory card of claim 15 wherein the transmission module comprises:
a selection device comprising:
a high input port;
a low input port;
a control port coupled to the clock port for receiving the clock signal; and
an output port;
wherein the selection device couples the high input port to the output port when the received clock signal is high, and the selection device couples the low input port to the output port when the received clock signal is low;
an inverter coupled to the clock tree for inverting the buffered clock signal and generating an inverted buffered clock signal;
a first flip-flop comprising:
an input port coupled to a first output port of the buffer controller;
an output port coupled to the low input port of the selection device; and
a control port coupled to the inverter for receiving the inverted buffered clock signal; and
a second flip-flop comprising:
an input port coupled to the second output port of the buffer controller;
an output port coupled to the high input port of the selection device; and
a control port coupled to the clock port for receiving the buffered clock signal.

19. The flash memory card of claim 15 wherein the transmission module comprises:
a selection device comprising:
a high input port;
a low input port;
a control port coupled to the clock port for receiving the clock signal; and
an output port;
wherein the selection device couples the high input port to the output port when the received clock signal is high, and the selection device couples the low input port to the output port when the received clock signal is low;
an inverter coupled to the clock tree for inverting the clock signal and generating an inverted buffered clock signal;
a first flip-flop comprising:
an input port coupled to a first output port of the buffer controller;
an output port coupled to the high input port of the selection device; and
a control port coupled to the inverter for receiving the inverted buffered clock signal; and
a second flip-flop comprising:
an input port coupled to the second output port of the buffer controller;
an output port coupled to the low input port of the selection device; and
a control port coupled to the clock tree for receiving the buffered clock signal.

20. The flash memory card of claim 15 wherein the transmission module comprises:
a selection device comprising:
a high input port;
a low input port;
a control port coupled to the clock port for receiving the clock signal; and
an output port;
wherein the selection device couples the high input port to the output port when the received clock signal is high, and the selection device couples the low input port to the output port when the received clock signal is low;
an inverter coupled to the clock tree for inverting the buffered clock signal and generating an inverted buffered clock signal;
a first flip-flop comprising:
an input port coupled to a first output port of the buffer controller;
an output port coupled to the low input port of the selection device; and
a control port coupled to the clock tree for receiving the buffered clock signal; and
a second flip-flop comprising:
an input port coupled to the second output port of the buffer controller;
an output port coupled to the high input port of the selection device; and
a control port coupled to the inverter for receiving the inverted buffered clock signal.

21. The flash memory card of claim 15 wherein the receiving module comprises:
an inverter coupled to the clock tree for inverting the buffered clock signal and generating an inverted buffered clock signal;
a first flip-flop comprising:
an input port coupled to the data port;
an output port coupled to a first input port of the buffer controller; and
a control port coupled to the clock tree for receiving the buffered clock signal; and
a second flip-flop comprising:
an input port coupled to the data port;
an output port coupled to a second input port of the buffer controller; and
a control port coupled to the inverter for receiving the inverted buffered clock signal.

22. The flash memory card of claim 15 wherein the receiving module comprises:
an inverter coupled to the clock tree for inverting the buffered clock signal and generating an inverted buffered clock signal;
a first flip-flop comprising:
an input port coupled to the data port;
an output port coupled to a first input port of the buffer controller; and
a control port coupled to the inverter for receiving the inverted buffered clock signal; and
a second flip-flop comprising:
an input port coupled to the data port;
an output port coupled to a second input port of the buffer controller; and
a control port coupled to the clock tree for receiving the buffered clock signal.

23. A flash memory system with higher transmission rate comprising:
a clock port;
a data port;
a host comprising:
a processor comprising a data bus port for transmitting a command;
a buffer controller comprising:
a data bus port coupled to the data bus port of the processor for receiving the command;
a first input port for receiving odd sets of data;
a second input port for receiving even sets of data;
a first output port for transmitting odd sets of data; and
a second output port for transmitting even sets of data;
an oscillator for outputting a clock signal;
a transmission module coupled between the buffer controller, the oscillator, and the data port for transmitting data from the buffer to the data port according to the clock signal; and
a receiving module coupled between the buffer controller, the oscillator, and the data port for receiving data from the data port and transmitting the received data to the buffer controller according to the clock signal; and
a flash memory card coupled to the clock port and the data port for transmitting or receiving data through the data port according to the clock signal.
